(19) United States
(12) Patent Application Publication
(10) Pub. No.: US 2026/0162248 A1
(43) Pub. Date: Jun. 11, 2026

(54) INFORMATION PROCESSING SYSTEM AND METHOD AND NON-TRANSITORY COMPUTER READABLE MEDIUM

(71) Applicant: FUJIFILM Business Innovation Corp., Tokyo (JP)

(72) Inventor: Kazuhiro OHKAWA, Kanaawa (JP)

(73) Assignee: FUJIFILM Business Innovation Corp., Tokyo (JP)

(21) Appl. No.: 19/205,430

(22) Filed: May 12, 2025

(30) Foreign Application Priority Data
Dec. 10, 2024 (JP) 2024-215460

(51) Int. Cl. G06T 7/00

(52) U.S. Cl. CPC G06T 7/001; G06T 2207/30144

(57) ABSTRACT

An information processing system includes a processor configured to: obtain, when performing inspection for a print image on a medium on which pages of a document are arranged by imposition by comparing the print image with correct answer data, information indicating that, instead of inspection areas included in the document, inspection areas corresponding to an imposition page on which the pages of the document are arranged by imposition are specified.

### CROSS-REFERENCE TO RELATED APPLICATIONS

This application is based on and claims priority under 35 USC 119 from Japanese Patent Application No. 2024-215460 filed Dec. 10, 2024.

### BACKGROUND

### (i) Technical Field

The present disclosure relates to an information processing system and method and a non-transitory computer readable medium.

### (ii) Related Art

Japanese Unexamined Patent Application Publication No. 2009-157858 discloses a print inspection device that inspects characters printed on a form by a printer. The print inspection device includes an obtainer, a transporter, an image reader, an image extractor, a setter, a decoder, and a page determiner. The obtainer obtains correct answer information which indicates correct answers of characters to be printed on a form by the printer and which is associated with information on pages and multiple print regions within each page in which character strings are to be printed. The transporter transports the form in one direction. The image reader reads an image in the form which is being transported by the transporter. The image extractor extracts multiple areas from the image read by the image reader. The setter presets multiple areas to be extracted by the image extractor in accordance with the print regions. The decoder decodes character strings within the multiple areas extracted by the image extractor from the images in the multiple areas. Based on the character strings in the multiple areas decoded by the decoder and the correct answer information obtained by the obtainer, the page determiner determines in which pages of the form the character strings in the multiple areas decoded by the decoder are included.

### SUMMARY

Aspects of non-limiting embodiments of the present disclosure relate to an information processing system in which, when performing inspection for a print image on a medium on which document pages are arranged by imposition by comparing inspection areas in the print image with correct answer data created based on the document pages, the inspection areas in the print image can be correctly associated with the corresponding portions of the correct answer data, unlike the configuration in which inspection areas based on the document pages are specified and are compared with the correct answer data.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a processor configured to: obtain, when performing inspection for a print image on a medium on which pages of a document are arranged by imposition by comparing the print image with correct answer data, information indicating that, instead of inspection areas included in the document, inspection areas corresponding to an imposition page on which the pages of the document are arranged by imposition are specified.

### BRIEF DESCRIPTION OF THE DRAWINGS

Exemplary embodiments of the present disclosure will be described in detail based on the following figures, wherein:

FIG. 1 is a schematic view illustrating the overall configuration of an information processing system according to a first exemplary embodiment;

FIG. 2 is a block diagram illustrating the hardware configuration of a print server in the information processing system;

FIG. 3 is a block diagram illustrating the hardware configuration of an inspection server in the information processing system;

FIG. 4 is a block diagram illustrating the hardware configuration of a printer in the information processing system;

FIG. 5 is a block diagram illustrating an example of the functional configuration of the information processing system according to the first exemplary embodiment;

FIG. 6 illustrates an example of an imposition page in the information processing system according to the first exemplary embodiment;

FIG. 7 illustrates an example of correct answer data in the information processing system according to the first exemplary embodiment;

FIG. 8 illustrates a first example of the arrangement of an imposition page in the information processing system according to the first exemplary embodiment;

FIGS. 9A and 9B illustrate a second example of the arrangement of an imposition page in the information processing system according to the first exemplary embodiment;

FIG. 9C illustrates a specific example of the arrangement of document pages to be bound by saddle stitching in the information processing system according to the first exemplary embodiment;

FIG. 10 illustrates a third example of the arrangement of an imposition page in the information processing system according to the first exemplary embodiment;

FIG. 11 is a flowchart illustrating a procedure of information processing executed by the print server of the information processing system according to the first exemplary embodiment;

FIG. 12 is a flowchart illustrating a procedure of information processing executed by the inspection server of the information processing system according to the first exemplary embodiment;

FIG. 13 is a block diagram illustrating an example of the functional configuration of an information processing system according to a second exemplary embodiment;

FIG. 14 illustrates an example of an imposition page in the information processing system according to the second exemplary embodiment;

FIG. 15 is a flowchart illustrating a procedure of information processing executed by a print server of the information processing system according to the second exemplary embodiment;

FIG. 16 is a flowchart illustrating a procedure of information processing executed by an inspection server of the information processing system according to the second exemplary embodiment;

FIG. 17 is a block diagram illustrating an example of the functional configuration of an information processing system according to a third exemplary embodiment;

FIG. 18 is a flowchart illustrating a procedure of information processing executed by a print server of the information processing system according to the third exemplary embodiment;

FIG. 19 is a flowchart illustrating a procedure of information processing executed by an inspection server of the information processing system according to the third exemplary embodiment;

FIG. 20 illustrates an example in which inspection areas in each imposition page, document page numbers, and correct answer data are associated with each other by a print server in an information processing system according to a modified example;

FIG. 21 is a schematic view illustrating the overall configuration of an information processing system according to a comparative example;

FIG. 22 illustrates an example of presettings set for inspection areas in the information processing system according to the comparative example;

FIG. 23 illustrates an example of correct answer data in the information processing system according to the comparative example; and

FIG. 24 illustrates a document and an example of the arrangement of an imposition page in the information processing system according to the comparative example.

### DETAILED DESCRIPTION

Exemplary embodiments of the disclosure will be described below with reference to the accompanying drawings. In the individual drawings, identical or equivalent elements or portions are designated by like reference numeral. For the sake of representation, the dimensional ratios in the drawings may be exaggerated and be different from the actual ratios.

### First Exemplary Embodiment

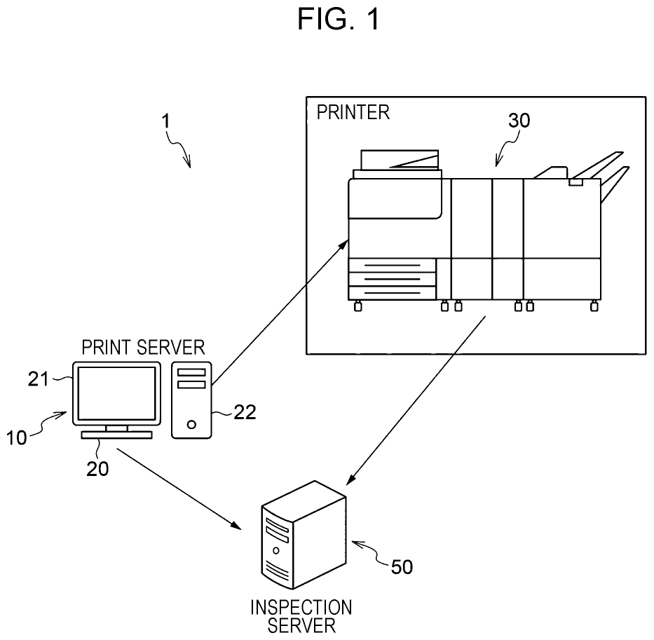

FIG. 1 is a schematic view illustrating the overall configuration of an information processing system according to a first exemplary embodiment.

### (Overall Configuration of Information Processing System)

As illustrated in FIG. 1, an information processing system 1 includes a print server 10, a printer 30, and an inspection server 50. In an example, the print server 10 and the inspection server 50 are constituted by different servers (different information processing apparatuses, for example). However, the print server 10 and the inspection server 50 may be constituted by one server (one information processing apparatus, for example).

The information processing system 1 is a system in which the print server 10, the inspection server 50, and the printer 30 are connected to each other via a network. The network may be the internet or may be a wired or wireless network. A wireless network is used in an example.

The print server 10 serves to cause the printer 30 to execute print processing based on a job and also to manage the printer 30. In an example, the print server 10 may provide a management service for managing the printer 30 by using a network. In an example, the print server 10 includes an input unit 20 used for performing various input operations, a display 21 that displays information, and an information processor 22 that processes information. The print server 10 also sends information used for inspecting a printed matter printed by the printer 30 to the inspection server 50. Details of processing to be executed by the print server 10 will be discussed later.

The printer 30 serves to print an image indicated by image data on a medium, such as a sheet, based on a job. When a printed matter is to be inspected, the printer 30 sends a scanned image generated by scanning the printed matter to the inspection server 50. Details of processing to be executed by the printer 30 will be discussed later.

The inspection server 50 serves to inspect a scanned image in accordance with inspection information received from the print server 10. Details of processing to be executed by the inspection server 50 will be discussed later.

### (Hardware Configuration of Print Server)

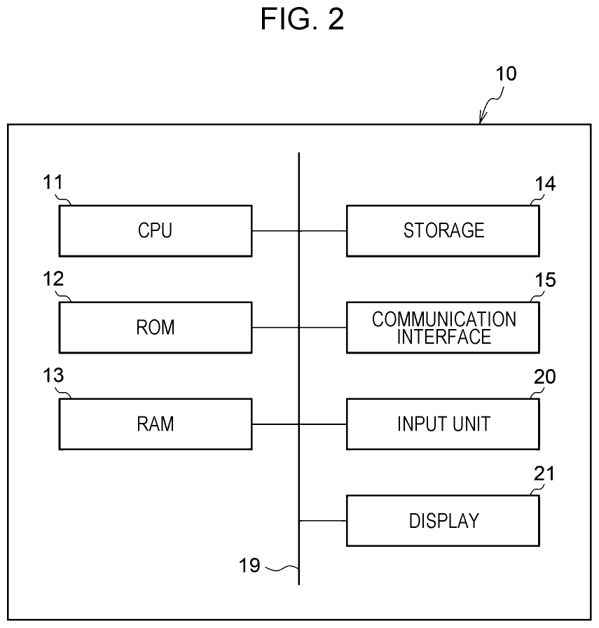

FIG. 2 is a block diagram illustrating the hardware configuration of the print server 10.

As illustrated in FIG. 2, the print server 10 includes a central processing unit (CPU) 11, a read only memory (ROM) 12, a random access memory (RAM) 13, a storage 14, a communication interface 15, an input unit 20, and a display 21. These elements are connected to each other via a bus 19 so that they can communicate with each other.

The CPU 11 executes various programs and controls the elements forming the print server 10. The CPU 11 is an example of a processor. That is, the CPU 11 reads a program from the ROM 12 or the storage 14 and executes the read program by using the RAM 13 as a work area. The CPU 11 controls the elements forming the print server 10 and executes various types of calculation processing in accordance with a program stored in the ROM 12 or the storage 14. In the first exemplary embodiment, an information processing program is stored in the ROM 12 or the storage 14.

The ROM 12 stores various programs and various items of data. The RAM 13 serves as a work area and temporarily stores a program or data. The storage 14 is constituted by a hard disk drive (HDD) or a solid state drive (SSD) and stores various programs including an operating system (OS) and various items of data.

The communication interface 15 is an interface to communicate with the printer 30, the inspection server 50, and other devices (not shown). Examples of the communication standard used for the communication interface 15 are Ethernet (registered trademark), FDDI, and Wi-Fi (registered trademark).

The input unit 20 is used by a user to perform various input operations. The input unit 20 includes a pointing device, such as a mouse, and a keyboard.

The display 21 displays various types of information. The display 21 is a liquid crystal display, for example.

### (Hardware Configuration of Inspection Server)

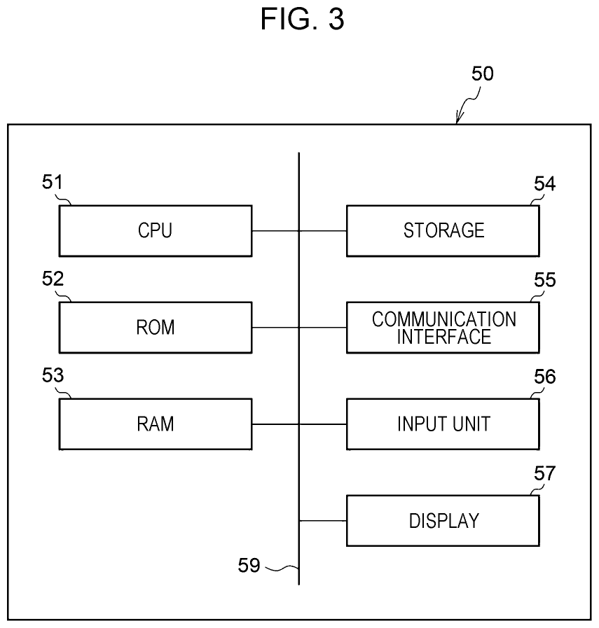

FIG. 3 is a block diagram illustrating the hardware configuration of the inspection server 50.

As illustrated in FIG. 3, the inspection server 50 includes a CPU 51, a ROM 52, a RAM 53, a storage 54, a communication interface 55, an input unit 56, and a display 57. These elements are connected to each other via a bus 59 so that they can communicate with each other.

The CPU 51 executes various programs and controls the elements forming the inspection server 50. The CPU 51 is an example of a processor. That is, the CPU 51 reads a program from the ROM 52 or the storage 54 and executes the read program by using the RAM 53 as a work area. The CPU 51 controls the elements forming the inspection server 50 and executes various types of calculation processing in accordance with a program stored in the ROM 52 or the storage 54. In the first exemplary embodiment, an inspection program is stored in the ROM 52 or the storage 54.

The ROM 52 stores various programs and various items of data. The RAM 53 serves as a work area and temporarily stores a program or data. The storage 54 is constituted by an HDD or an SSD and stores various programs including an OS and various items of data.

The communication interface 55 is an interface to communicate with the print server 10 and the printer 30. Examples of the communication standard used for the communication interface 55 are Ethernet (registered trademark), FDDI, and Wi-Fi (registered trademark). The input unit 56 is similar to the input unit 20 of the print server 10, and the display 57 is similar to the display 21 of the print server 10.

### (Hardware Configuration of Printer)

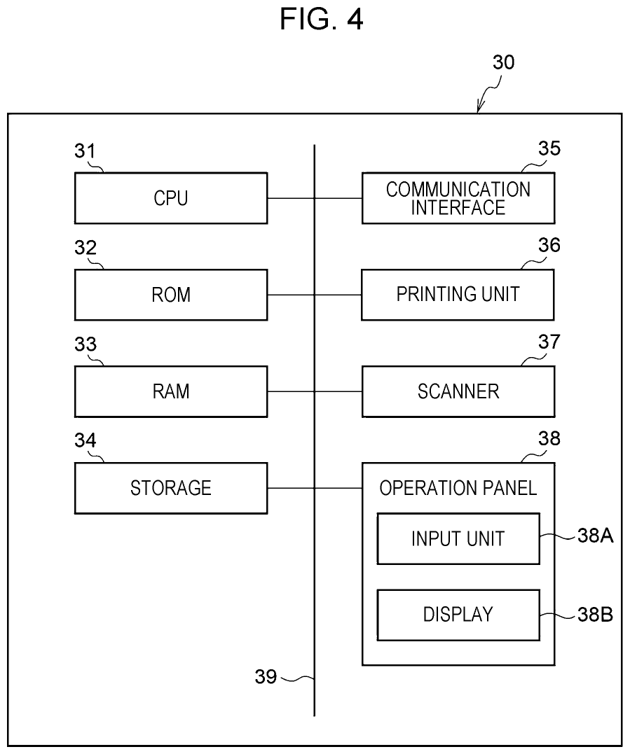

FIG. 4 is a block diagram illustrating the hardware configuration of the printer 30.

As illustrated in FIG. 4, the printer 30 includes a CPU 31, a ROM 32, a RAM 33, a storage 34, a communication interface 35, a printing unit 36, a scanner 37, and an operation panel 38. These elements are connected to each other via a bus 39 so that they can communicate with each other. The printer 30 may include another element.

The configurations of the CPU 31, ROM 32, RAM 33, storage 34, and communication interface 35 are similar to those of the CPU 11, ROM 12, RAM 13, storage 14, and communication interface 15 of the print server 10.

The printing unit 36 prints an image indicated by image data on a medium, such as a sheet, based on a job. In an example, the printing unit 36 prints an image on a medium by using an electrophotographic system. Instead of the electrophotographic system, the printing unit 36 may use an inkjet system to print an image on a medium.

The scanner 37 optically reads a target object and obtains a scanned image, that is, scan data. For example, when a printed matter printed by the printing unit 36 is to be inspected, the scanner 37 reads the printed matter and obtains a scanned image.

The operation panel 38 includes an input unit 38A and a display 38B. The input unit 38A is used for performing various input operations. The display 38B is a liquid crystal display, for example, and displays various types of information. The touch panel system is employed for the display 38B, and part of the display 38B serves as the input unit 38A.

### (Configuration of Information Processing System of Comparative Example)

An information processing system 800 of a comparative example will be described below.

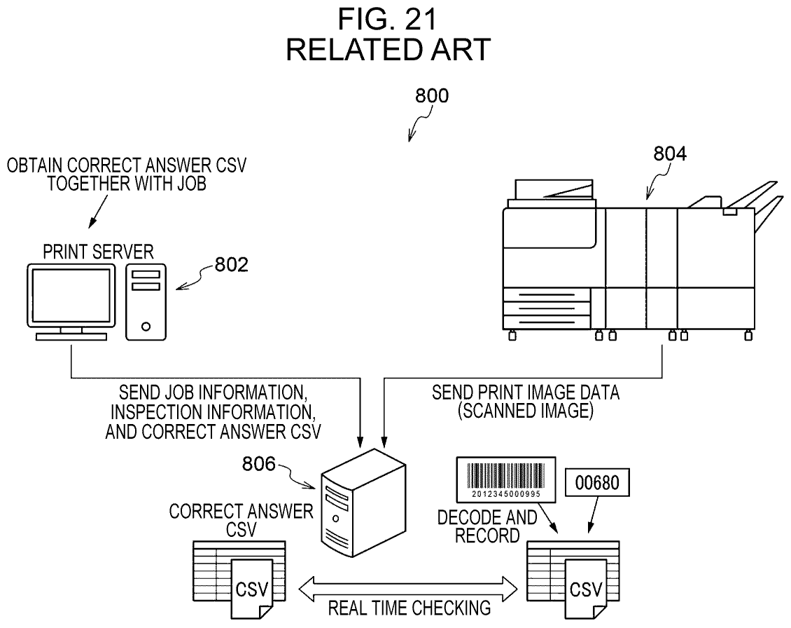

FIG. 21 is a schematic view illustrating the overall configuration of the information processing system 800 of a comparative example. As shown in FIG. 21, the information processing system 800 includes a print server 802, a printer 804, and an inspection server 806. The information processing system 800 serves to decode barcodes and text of a scanned image generated by reading a printed matter printed by the printer 804 into character strings and to inspect the decoded character strings.

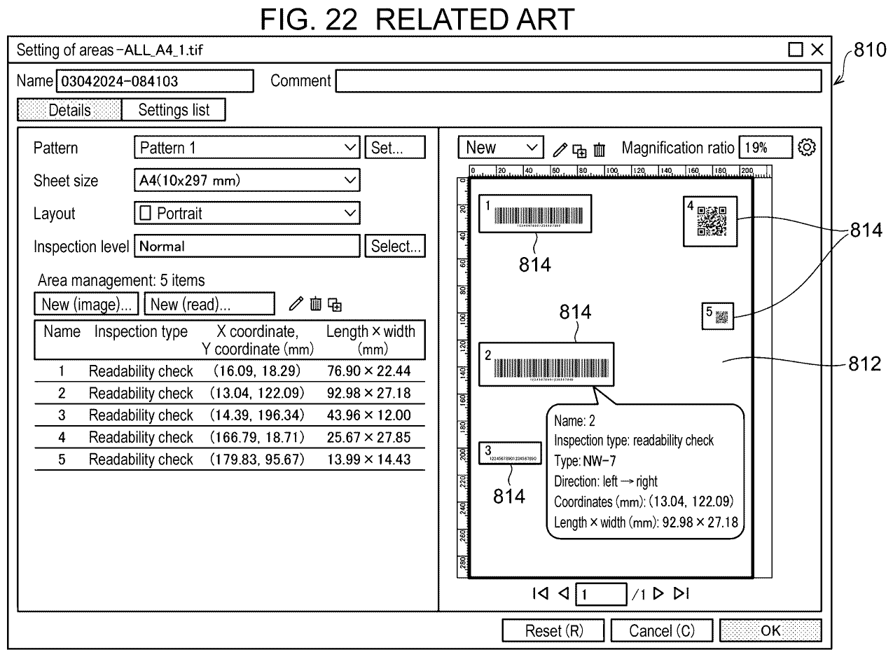

As shown in FIG. 22, on a display screen 810, the print server 802 specifies inspection areas 814 in advance in accordance with at which positions the barcodes are located on a document 812. Specifying the inspection areas 814 is a presetting operation.

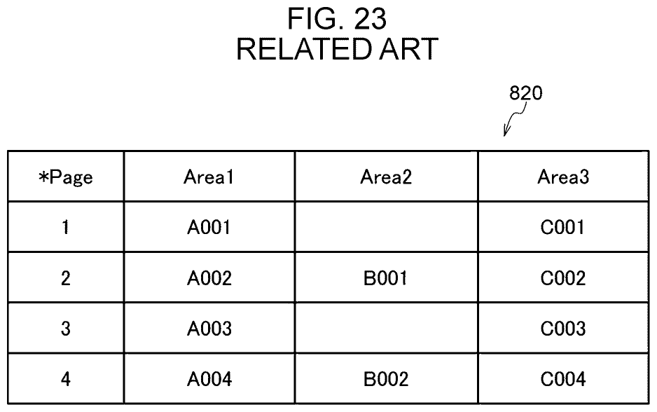

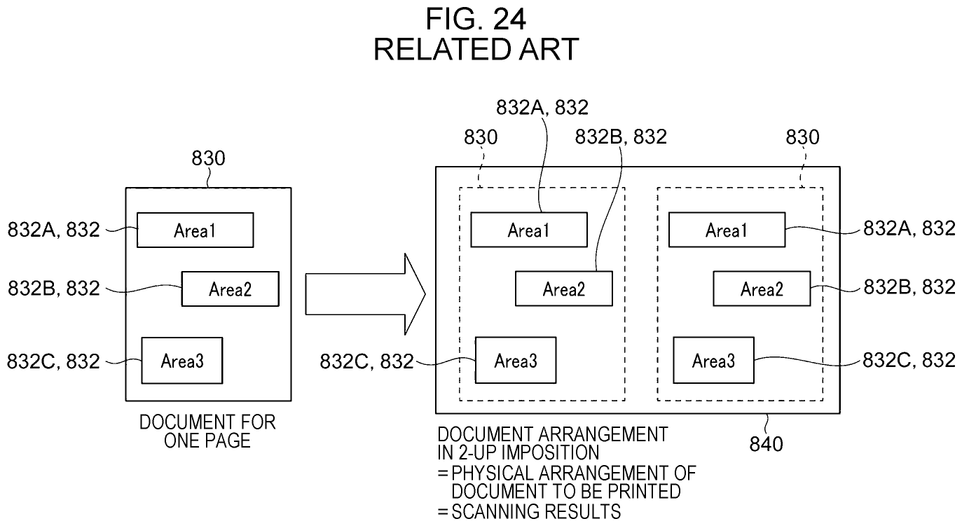

The print server 802 obtains correct answer data 820 shown in FIG. 23, together with a job. In one example, the correct answer data 820 is a list of character strings decoded from barcodes, which are inspection areas 832 on a document 830 shown in FIG. 24. In this example, the correct answer data 820 is correct answer CSV, which stands for comma separated values. The CSV is text data using commas to separate individual values. For example, the first page of the document 830 includes a first area 832A, a second area 832B, and a third area 832C as the inspection areas 832 (see FIG. 24).

The print server 802 sends job information, inspection information, and the correct answer data 820 to the inspection server 806 (see FIG. 21).

The printer 804 prints an image on a medium, such as a sheet, based on document data to generate a printed matter and scans the printed matter to generate print image data, that is, a scanned image. The printer 804 sends the print image data (scanned image) to the inspection server 806 (see FIG. 21).

The inspection server 806 extracts and reads the inspection areas from the print image data (scanned image) and compares the read inspection areas with the correct answer CSV to check whether they match each other (see FIG. 21). In one example, the inspection server 806 performs comparison inspection to compare (that is, verifies) the read inspection areas with the correct answer CSV in real time.

In the above-described comparison inspection, the correct answer data 820 is usually created based on document pages (logical pages) (see FIG. 23). This is because, when the correct answer data 820 is created from source data of the document 830, it is inevitably based on the document pages of the document 830. On the other hand, when printing the document 830 by the printer 804, there may be a case in which the pages of the document 830 are arranged by imposition and are then printed by the printer 804. In this case, document pages of the document 830 and imposition pages (physical pages) 840 of the document 830 do not match each other. That is, the document pages are not the same as the physical pages.

As shown in FIG. 24, in the case of 2-up imposition, the first page and the second page of the document 830 are disposed on the first imposition page (physical page) 840, and the third page and the fourth page of the document 830 are disposed on the second imposition page (physical page) 840. As a result, it is possible that the page numbers indicated by the correct answer data 820 do not match the page numbers of the scanned image, which may fail to perform accurate inspection.

Even if the page numbers of the document 830 included in the imposition page 840 are known, it may not be possible to identify which page of the document 830 is disposed on which location on the imposition page 840 since multiple document pages are disposed on the same imposition page 840. For example, in the example in FIG. 24, it is not possible to know whether a page of the document 830 is located on the left side or the right side of the imposition page 840. As a result, it is not possible to correctly associate the portions of the correct answer data 820 with the inspection areas of a printed matter on a medium on which document pages are arranged by imposition. To handle this issue, correct answer data may be created based on the imposition page. This is however time-and effort-consuming.

The information processing system 1 of the first exemplary embodiment executes certain processing to avoid mismatching between the portions of correct answer data and inspection areas of a printed matter on a medium on which document pages are arranged by imposition. An example of the functional configuration and the processing content of the information processing system 1 will be discussed below.

### (Functional Configuration of Information Processing System)

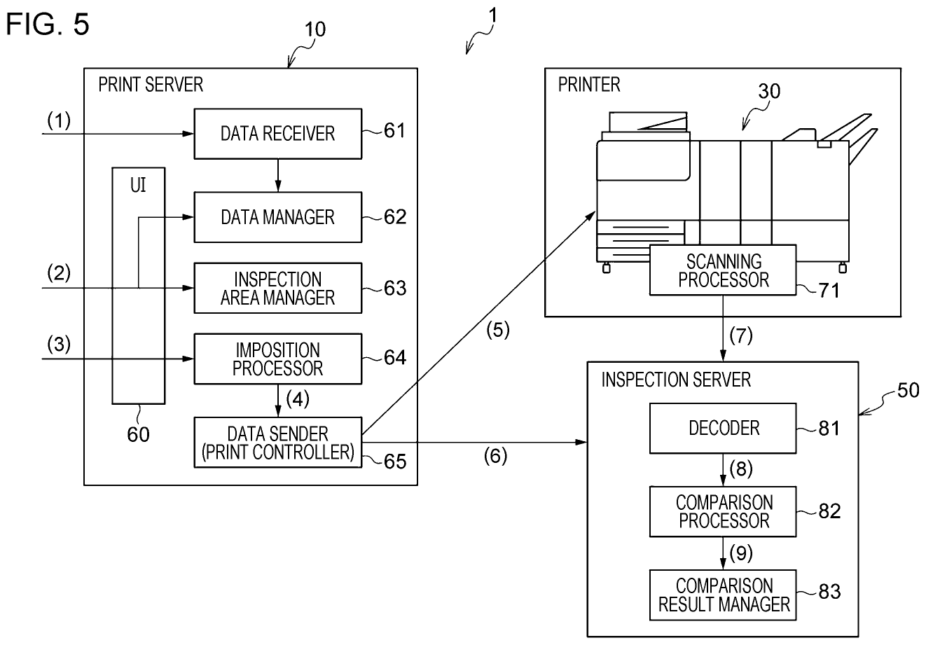

FIG. 5 is a block diagram illustrating an example of the functional configuration of the information processing system 1.

As illustrated in FIG. 5, the print server 10 includes, as functional modules, a data receiver 61, a data manager 62, an inspection area manager 63, an imposition processor 64, and a data sender 65. The functional modules are implemented as a result of the CPU 11 reading the information processing program stored in the ROM 12, loading it to the RAM 13, and executing it. The print server 10 also includes a user interface (UI) 60. The UI 60 is an interface used for sending and receiving information among users of a computer.

The printer 30 includes a scanning processor 71 as a functional module. The printer 30 may include functional modules other than the scanning processor 71, such as a print processor, though such functional modules are not shown. The functional modules are implemented as a result of the CPU 31 reading the information processing program stored in the ROM 32, loading it to the RAM 33, and executing it.

The inspection server 50 includes a decoder 81, a comparison processor 82, and a comparison result manager 83 as functional modules. The functional modules are implemented as a result of the CPU 51 reading the information processing program stored in the ROM 52, loading it to the RAM 53, and executing it.

The data receiver 61 of the print server 10 obtains various items of data. More specifically, the data receiver 61 receives data on a document and correct answer data linked with the document from an external device (see (1) in FIG. 5). In one example, the print server 10 is connected to a user terminal (not shown) via a network and receives data on a document and correct answer data linked with the document from the user terminal. In one example, the data receiver 61 obtains job information.

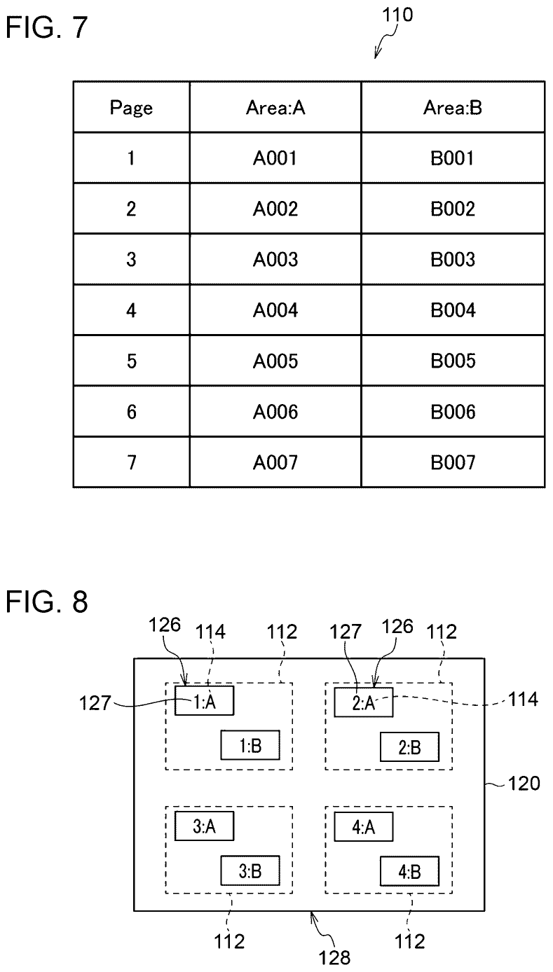

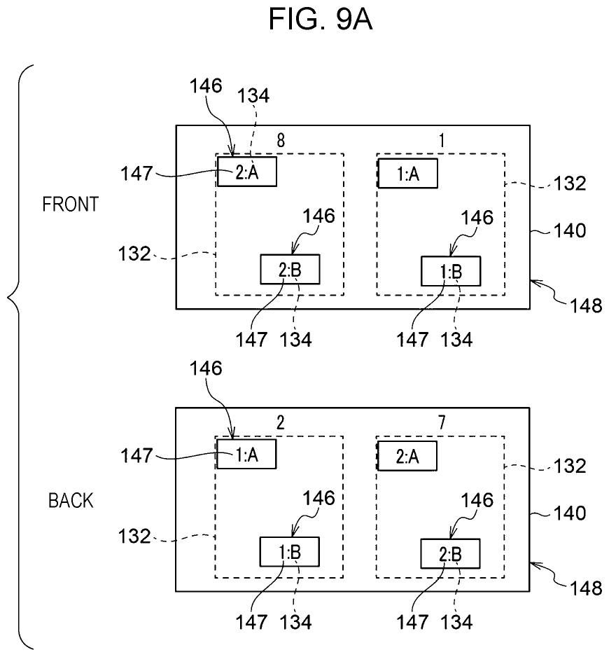

FIG. 7 illustrates correct answer data 110 in a first example. FIG. 8 illustrates an imposition page (physical page) 120 on which pages of a document 112 are arranged by imposition in the first example. “Imposition” is to arrange multiple pages of document data on a medium, such as a sheet, in a correct order when creating a printed matter having multiple pages. As shown in FIG. 7, the correct answer data 110 is a list of character strings decoded from barcodes, which are inspection areas 114 (see FIG. 8) in the document 112. The correct answer data 110 is created based on the document pages.

The data manager 62 registers the received document data and correct answer data linked with the document (see (1) in FIG. 5). For instance, in the first example shown in FIGS. 7 and 8, the data manager 62 registers data on the document 112 and the correct answer data 110 linked with the document 112. The data manager 62 registers (stores) the correct answer data 110 in the storage 14 (see FIG. 2), for example.

In response to a user instruction or automatically, the inspection area manager 63 creates and edits inspection areas for a corresponding imposition page (physical page) in accordance with the document and registers the inspection areas included in this imposition page (see (2) in FIG. 5). As the inspection areas, all the target areas within the corresponding imposition page (physical page) are set. Operations in (1) and (2) in FIG. 5 are examples of a presetting operation. The inspection areas may be received by the data receiver 61.

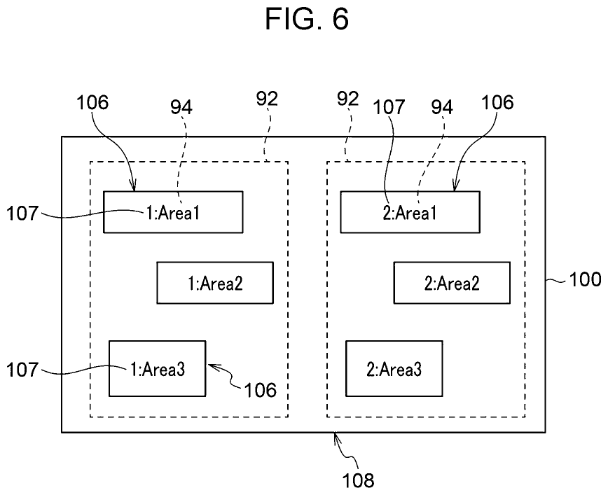

FIG. 6 illustrates an example of an imposition page (physical page) 100 on which two pages of a document 92 are disposed by imposition. The imposition page 100 shown in FIG. 6 is an imposition page generated, assuming that the correct answer data (a list of character strings decoded from barcodes, which are inspection areas 94 in the document 92) is created based on the pages of the document 92 and that the pages of the document 92 are arranged by imposition. In this case, the inspection area manager 63 obtains information 108 indicating that, instead of the inspection areas 94 in the document 92, inspection areas 106 in the corresponding imposition page 100 are specified. The information 108 is an example of specifying information of the inspection areas 106. In a region where each page of the document 92 is disposed in the imposition page 100, the inspection area manager 63 specifies a document page imposition number 107, which corresponds to each document page, for each inspection area 106 to be compared with the correct answer data. The document page imposition number 107 is a number to be associated with a corresponding document page number indicated by the correct answer data. However, the document page imposition number 107 is a number different from the value of the corresponding document page number indicated by the correct answer data. In FIG. 6, “1” at the head of “1:Area2” is the document page imposition number 107. Based on the document page imposition numbers 107, the inspection server 50 determines which document page imposition number 107 is to be compared with which page of the correct answer data and associates the determined document page imposition number 107 with the determined page of the correct answer data.

FIG. 8 illustrates the imposition page (physical page) 120 on which the pages of the document 112 are arranged in the 4-up (2×2-up) or repeat imposition in the first example. More specifically, FIG. 8 illustrates an example of information 128 indicating that, instead of inspection areas 114 in the document 112, inspection areas 126 in the corresponding imposition page 120 are specified. The information 128 is an example of specifying information of the inspection areas 126. “Repeat” is to dispose the same document page on one imposition page 120. In response to a user instruction or automatically, the inspection area manager 63 creates and edits inspection areas 126 for the corresponding imposition page 120 in accordance with the registered document 112. As discussed above, the imposition page 120 in the first example is an imposition page generated, assuming that the correct answer data (a list of character strings decoded from barcodes, which are the inspection areas 114 on the document 112) is created based on the pages of the document 112 and that the pages of the document 112 are arranged by imposition. The inspection area manager 63 thus specifies a document page imposition number 127 for each inspection area 126 in the corresponding imposition page 120. The inspection area manager 63 registers the information 128 indicating that the inspection areas 126 in the corresponding imposition page 120 are specified (and also that the document page imposition numbers 127 are specified). The information 128 is registered (stored) in the storage 14 (see FIG. 2), for example.

The imposition processor 64 executes processing for starting printing in response to a user operation (see (3) in FIG. 5). The imposition processor 64 also executes processing for inspecting a printed matter in response to a user operation. The imposition processor 64 makes calculation for the imposition arrangement based on job information (job settings, for example) so as to determine the document page numbers included in the corresponding imposition page (physical page). In the first example in FIG. 8, the imposition processor 64 determines the page numbers of the document 112 included in the corresponding imposition page 120. The imposition processor 64 then sends the determined page numbers of the document 112 included in the corresponding imposition page 120 to the data sender 65 (see (4) in FIG. 5).

The data sender 65 serves as a print controller. More specifically, the data sender 65 sends a print instruction to the printer 30, together with target print data (that is, image data) (see (5) in FIG. 5). This causes the printer 30 to start print processing.

The data sender 65 also sends information indicating the inspection areas included in the corresponding imposition page (physical page), the correct answer data, and the document page numbers included in this imposition page to the inspection server 50 (see (6) in FIG. 5). More specifically, the data sender 65 sends information indicating the inspection areas included in the corresponding imposition page (physical page) to the decoder 81 and the correct answer data and the document page numbers included in this imposition page to the comparison processor 82. The inspection server 50 may include a data receiver, in which case, the data sender 65 may send information indicating the inspection areas, the correct answer data, and the document page numbers included in the corresponding imposition page (physical page) to the data receiver. In the first example in FIG. 8, the information 128 indicating the inspection areas 126 in the corresponding imposition page 120 (and also the document page imposition numbers 127), the correct answer data 110, and the page numbers of the document 112 included in this imposition page (physical page) 120 are sent to the inspection server 50.

With the provision of the data sender 65, a system that executes a process from the receiving of job information until the execution of printing and a system that inspects barcodes are separately provided for the information processing system 1. Sending of various items of data from the data sender 65 to the inspection server 50 may be started in response to the data sender 65 sending a print instruction to the printer 30. This can synchronize the printing and scanning timing of the printer 30 with the sending timing of various items of data to the inspection server 50, which is suitable for real-time comparison inspection.

The scanning processor 71 scans the imposition page (physical page) on which an image is printed and sends the imposition page number (physical page number) and the scanned image to the decoder 81 of the inspection server 50 (see (7) in FIG. 5).

The decoder 81 decodes each inspection area included in a scanned image, based on the inspection areas included in the corresponding imposition page (physical page). The decoder 81 then sends the imposition page number (physical page number) and the decoding results to the comparison processor 82 (see (8) in FIG. 5).

In the first example in FIG. 8, the decoder 81 decodes the scanned image of the inspection area 126 “1:A” and obtains a decoding result “A001”, for example. As shown in FIG. 7, the decoding result “A001” is correct. The decoder 81 also decodes the scanned image of the inspection area 126 “2:A” and obtains a decoding result “A005”, for example. As shown in FIG. 7, the decoding result “A005” is wrong. In this manner, a decoding result is not always correct.

The comparison processor 82 performs comparison inspection to compare the decoding results with the corresponding portions of the correct answer data that are associated with the document pages included in the imposition pages. The comparison processor 82 notifies the comparison result manager 83 of the comparison inspection results (see (9) in FIG. 5). In comparison inspection, to determine the positions of the document pages within an imposition page (physical page), such as to determine whether a document page is arranged on the left side or the right side of the imposition page in FIG. 8, the document pages may be sorted and arranged in ascending order of the document page imposition number, for example.

In the first example in FIGS. 7 and 8, the comparison processor 82 performs comparison inspection of the document 112 including seven pages in the 4-up or repeat imposition. In the case of the 4-up imposition, for example, the first page of the imposition page 120 (may be called the first imposition page, for example), that is, page 1 to page 4 of the document 112, are subjected to comparison inspection. “1:A” is compared with the value in the area A of the first page of the document in the correct answer data 110. “2:A” is compared with the value in the area A of the second page of the document in the correct answer data 110. “3:A” is compared with the value in the area A of the third page of the document in the correct answer data 110. “4:A” is compared with the value in the area A of the fourth page of the document in the correct answer data 110. Likewise, “1:B”, “2:B”, “3:B”, and “4:B” are also compared with the corresponding values in the area B of the correct answer data 110.

For example, the comparison processor 82 compares the decoding result “A001” with the corresponding item of correction answer data “A001” associated with “1:A” and determines that the comparison result is “OK”. The comparison processor 82 compares the decoding result “A005” with the corresponding item of correction answer data “A002” associated with “2:A” and determines that the comparison result is “NG”. The comparison processor 82 compares the other decoding results with the corresponding items of correction answer data in a similar manner. The comparison processor 82 notifies the comparison result manager 83 of the comparison inspection results.

Then, in the 4-up imposition, the comparison processor 82 performs comparison inspection of the second imposition page, that is, page 5 to page 7 of the document 112. “1:A” is compared with the value in the area A of the fifth page of the document in the correct answer data 110. “2:A” is compared with the value in the area A of the sixth page of the document in the correct answer data 110. “3:A” is compared with the value in the area A of the seventh page of the document in the correct answer data 110. “4:A” is not eligible for comparison inspection, but is not treated as an error in this example. Likewise, “1:B”, “2:B”, and “3:B” are also compared with the corresponding values in the area B in the correct answer data 110 and “4:B” is handled as in “4:A”.

In the case of the repeat (2×2) imposition, for example, the first imposition page, that is, page 1 of the document, is subjected to comparison inspection. “1:A”, “2:A”, “3:A”, and “4:A” are compared with the value in the area A of the first page of the document in the correct answer data 110. “1:B”, “2:B”, “3:B”, and “4:B” are compared with the value in the area B of the first page of the document in the correct answer data 110. Then, the second imposition page, that is, page 2 of the document, is subjected to comparison inspection. “1:A”, “2:A”, “3:A”, and “4:A” are compared with the value in the area A of the second page of the document in the correct answer data 110. “1:B”, “2:B”, “3:B”, and “4:B” are compared with the value in the area B of the second page of the document in the correct answer data 110. Comparison inspection is also performed on the third and subsequent imposition pages in a similar manner.

The comparison result manager 83 manages the comparison inspection results. For example, the comparison result manager 83 stores the comparison inspection results in the storage 54 and notifies a user of the comparison results.

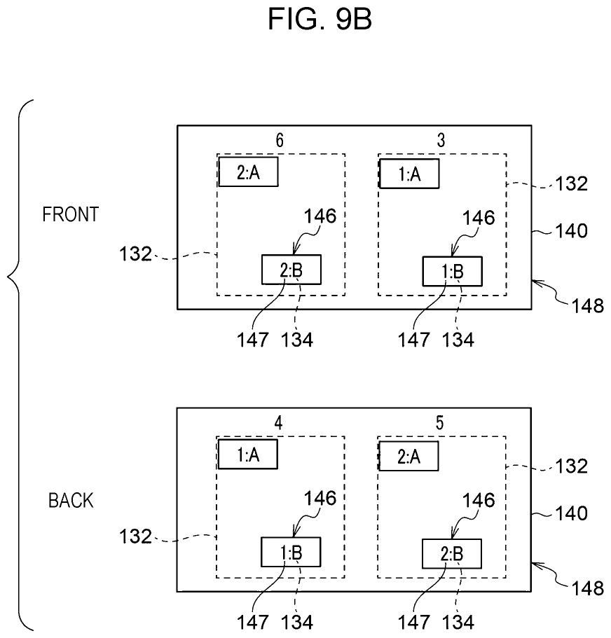

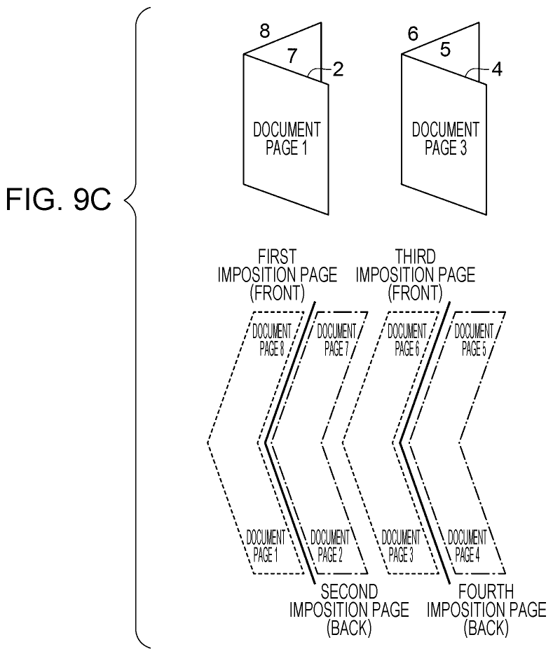

FIGS. 9A and 9B illustrate an imposition page 140 (physical page) on which pages of a document 132 are arranged by imposition in a second example. More specifically, FIGS. 9A and 9B illustrate an example of information 148 indicating that, instead of inspection areas 134 in the document 132, inspection areas 146 corresponding to the imposition page 140 are specified. In the second example, correct answer data 110 similar to that shown in FIG. 7 is used. In the second example, the comparison processor 82 performs comparison inspection of the document 132 having eight pages in saddle stitching, as shown in FIGS. 9A and 9B. The content of the front side of the document 132 is the same as that of the back side of the document 132. However, the arrangement of the front side of the imposition page (physical page) 140 and that of the back side of the imposition page 140 are different, and two patterns are created for the front side and the back side of the imposition page 140. FIG. 9C illustrates a specific example in which eight document pages to be bound by saddle stitching are arranged by imposition with respect to the fold lines of imposition pages. As shown in FIG. 9C, page 1 and page 8 of the document are arranged on both sides with respect to the fold line of the first imposition page (front side), and page 2 and page 7 of the document are arranged on both sides with respect to the fold line of the second imposition page (back side). Page 3 and page 6 of the document are arranged on both sides with respect to the fold line of the third imposition page (front side), and page 4 and page 5 of the document are arranged on both sides with respect to the fold line of the fourth imposition page (back side).

As illustrated in FIGS. 9A and 9B, a document page imposition number 147 is appended to each inspection area 146 in the imposition page (physical page) 140. As shown in FIG. 9A, the pattern for the front side is set for the first imposition page, that is, page 1 and page 8 of the document. “1” at the head of “1:A” and “2” at the head of “2:A” are the document page imposition numbers 147. “1:A” is compared with the value in the area A of the first page of the document in the correct answer data 110. “2:A” is compared with the value in the area A of the eighth page of the document in the correct answer data 110 (not shown in FIG. 7). As shown in FIG. 9A, the pattern for the back side is set for the second imposition page, that is, page 2 and page 7 of the document. “1:A” is compared with the value in the area A of the second page of the document in the correct answer data 110. “2:A” is compared with the value in the area A of the seventh page of the document in the correct answer data 110.

As shown in FIG. 9B, the pattern for the front side is set for the third imposition page, that is, page 3 and page 6 of the document. “1:A” is compared with the value in the area A of the third page of the document in the correct answer data 110. “2:A” is compared with the value in the area A of the sixth page of the document in the correct answer data 110. As shown in FIG. 9B, the pattern for the back side is set for the fourth imposition page, that is, page 4 and page 5 of the document. “1:A” is compared with the value in the area A of the fourth page of the document in the correct answer data 110. “2:A” is compared with the value in the area A of the fifth page of the document in the correct answer data 110. The above-described patterns can also be used for inspecting a document to be bound in side stitching.

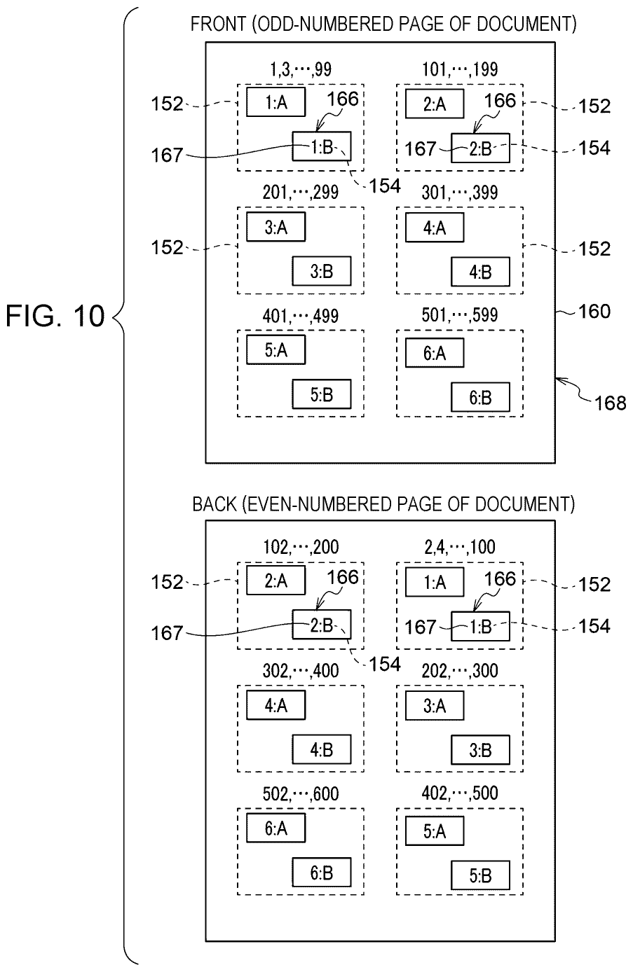

FIG. 10 illustrates an imposition page (physical page) 160 on which pages of a document 152 are arranged by imposition in a third example. More specifically, FIG. 10 illustrates an example of information 168 indicating that, instead of inspection areas 154 in the document 152, inspection areas 166 corresponding to the imposition page 160 are specified. In the third example, correct answer data 110 similar to that shown in FIG. 7 is used. In the third example, 600 pages of the document 152 are disposed on imposition pages (six pages of the document 152 are disposed on each imposition page) in the cut-and-stack layout (double sided), as shown in FIG. 10, and then, comparison inspection is performed. The content of the front side of the document 152 is the same as that of the back side of the document 152. However, the arrangement of the front side of the imposition page (physical page) 160 and that of the back side of the imposition page 160 are different, and two patterns are created for the front side and the back side of the imposition page 160. A document page imposition number 167 is appended to each inspection area 166 in the imposition page 160. The approach to performing comparison inspection is similar to that in FIGS. 9A and 9B. If inspection is performed only for the single side, only one pattern is created.

### (Operation of Information Processing System)

The operation of the information processing system 1 will now be described below.

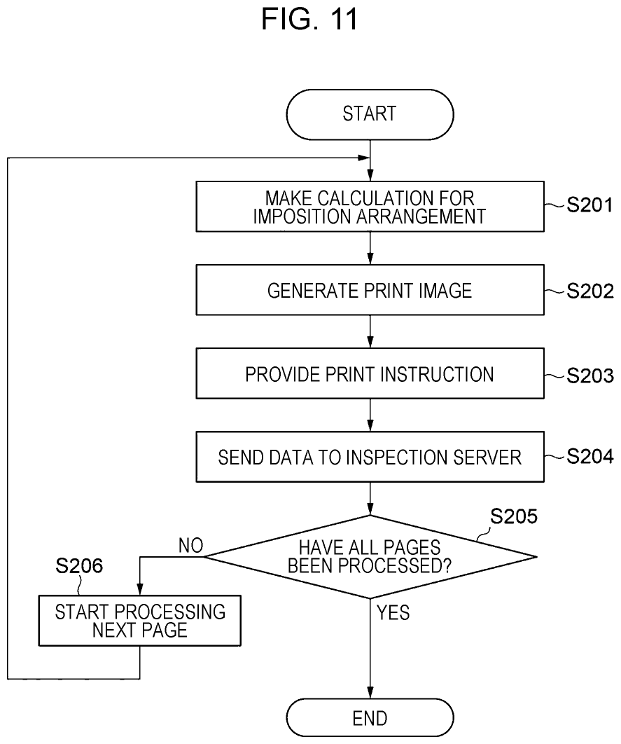

FIG. 11 is a flowchart illustrating a procedure of information processing executed by the print server 10 of the information processing system 1. The information processing is executed as a result of the CPU 11 reading the information processing program from the ROM 12, loading it to the RAM 13, and executing it.

The print server 10 performs the following presetting operation. The CPU 11 receives data on a document and correct answer data linked with the document from an external device and registers the received data in the data manager 62 (see (1) in FIG. 5). In response to a user operation or automatically, the CPU 11 creates and edits inspection areas for a corresponding imposition page (physical page) in accordance with the document so as to obtain information indicating that the inspection areas in this imposition page are specified and registers this information in the inspection area manager 63 (see (2) in FIG. 5).

For example, the CPU 11 receives data on the document 112 (see FIG. 8) and the correct answer data 110 (see FIG. 7) linked with the document 112 and registers the received data in the data manager 62. The CPU 11 also receives job information. For example, as shown in FIG. 8, the CPU 11 creates inspection areas 126 in the corresponding imposition page (physical page) 120 in accordance with the document 112 and registers the information 128 on the inspection areas 126 in the inspection area manager 63. At this time, the CPU 11 also specifies the document page imposition number 127 for each inspection area 126 to be subjected to comparison inspection and includes the specified document page imposition number 127 in the information 128. Then, the CPU 11 provides an instruction to start printing and inspection in response to a user operation.

In step S201 in FIG. 11, when printing is started, the CPU 11 makes calculation for the imposition arrangement. More specifically, the CPU 11 makes calculation for the imposition arrangement based on job information (job settings, for example) so as to determine the document page numbers included in the corresponding imposition page. For example, as shown in FIG. 8, the CPU 11 determines the page numbers of the document 112 included in the corresponding imposition page 120. The page numbers of the document 112 are the actual page numbers and are different from the document page imposition numbers 127.

In step S202, the CPU 11 generates data on a print image. For example, the CPU 11 generates data on a print image, based on the document pages and the document page numbers included in the corresponding imposition page.

In step S203, the CPU 11 provides a print instruction to the printer 30. The print instruction is provided for each page (imposition page in this example). The CPU 11 sends the print image data (target print data) to the printer 30, together with the print instruction.

In step S204, the CPU 11 sends data for inspection to the inspection server 50. The data for inspection includes data on the inspection areas in the corresponding imposition page (physical page), correct answer data, and document page numbers included in this imposition page. For example, the information 128 on the inspection areas 126 in the imposition page 120 shown in FIG. 8, the correct answer data 110 shown in FIG. 7, and the page numbers of the document 112 included in this imposition page (physical page) 120 are sent to the inspection server 50.

In step S205, the CPU 11 determines whether all the pages have been processed. The pages are imposition pages in this example.

If not all the pages have been processed (NO in step S205), the CPU 11 proceeds to step S206 to process the next page. In this case, the CPU 11 executes steps S201 through S205 for the next page.

If all the pages have been processed (YES in step S205), the CPU 11 finishes the processing executed based on the information processing program.

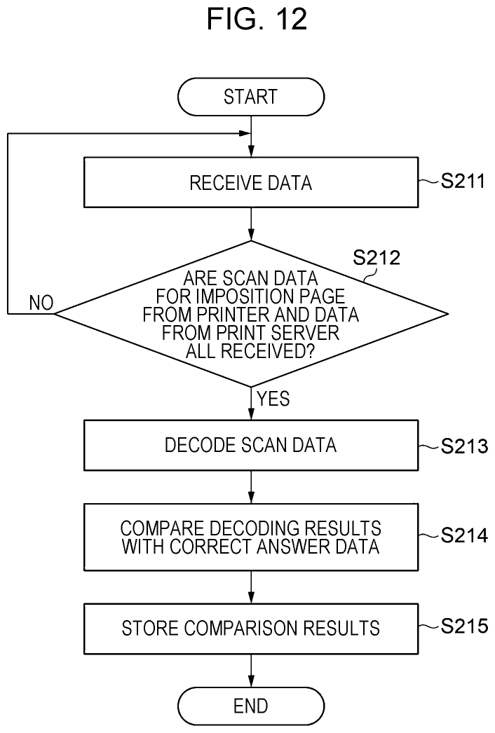

FIG. 12 is a flowchart illustrating a procedure of information processing executed by the inspection server 50 of the information processing system 1. The information processing is executed as a result of the CPU 51 reading the inspection program from the ROM 52, loading it to the RAM 53, and executing it.

In step S211 in FIG. 12, the CPU 51 receives data from the print server 10 and the printer 30. The data received from the print server 10 includes data on the inspection areas in the corresponding imposition page (physical page), correct answer data, and document page numbers included in this imposition page. The data received from the printer 30 includes scan data generated by scanning a printed matter (scanned image data).

In step S212, the CPU 51 determines whether scan data for the imposition page from the printer 30 and data from the print server 10 are all received. For example, if scan data for the imposition page has been received from the printer 30 and if data on the inspection areas, correct answer data, and document page numbers included in the corresponding imposition page has been received from the print server 10, the CPU 51 determines that the necessary items of data are all received.

If scan data for the imposition page from the printer 30 and data from the print server 10 are not all received (NO in step S212), the CPU 51 returns to step S211 and waits until the necessary items of data are all received.

If scan data for the imposition page from the printer 30 and data from the print server 10 are all received (YES in step S212), the CPU 51 decodes the scan data in step S213. For example, based on the inspection areas 126 in the corresponding imposition page (physical page) 120, as shown in FIG. 8, the CPU 51 decodes each inspection area 126 indicated by the scan data.

In step S214, the CPU 51 compares the decoding results with the correct answer data. For example, the CPU 51 compares the decoding results with the corresponding portions of the correct answer data that are associated with the inspection areas of the document pages included in the corresponding imposition page and checks whether they match each other. For example, as shown in FIG. 8, the document page imposition number 127 is appended to each inspection area 126 to be subjected to comparison inspection. Based on the document page imposition number 107 appended to a certain inspection area 126, the CPU 51 determines which portion of the correct answer data 110 in FIG. 7 is to be compared with this inspection area 126.

In step S215, the CPU 51 stores the comparison results, that is, the results of comparison inspection. Then, the CPU 51 finishes the processing executed based on the inspection program.

In the above-described information processing system 1, when performing inspection for a print image on a medium on which the pages of a document are arranged by imposition by comparing the print image with correct answer data, the CPU 11 or 51 obtains information indicating that, instead of inspection areas included in the document, inspection areas corresponding to an imposition page on which the pages of the document are arranged are specified. For example, as shown in FIGS. 7 and 8, inspection may be performed for a print image (scanned image, for example) on a medium on which the pages of the document 112 are arranged by imposition by comparing the print image with the correct answer data 110. In this case, the CPU 11 obtains the information 128 indicating that, instead of the inspection areas 114 (area A and area B, for example) in the document 112, the inspection areas 126 (“1:A” and “1:B” in FIG. 8, for example) which correspond to the imposition page 120 on which the pages of the document 112 are arranged by imposition are specified.

In the information processing system 1, the CPU 51 of the inspection server 50 inspects the above-described inspection areas in the print image on the medium by comparing the inspection areas with the correct answer data that is associated with the document pages included in the imposition page and including the inspection areas, based on the above-described information that, instead of the inspection areas in the document, the inspection areas corresponding to the imposition page are specified. For example, as shown in FIGS. 7 and 8, the CPU 51 inspects the inspection areas in the scanned image by comparing the inspection areas with the correct answer data 110 that is associated with the pages of the document 112 included in the imposition page 120 and including the inspection areas 126, based on the information 128 indicating that the inspection areas 126 corresponding to the imposition page 120 are specified.

The CPU 11 of the print server 10 obtains correct answer data linked with a document. The CPU 11 also obtains specifying information indicating that, instead of inspection areas in the document, inspection areas in a corresponding imposition page are specified. The CPU 11 determines the document page numbers included in the imposition page, based on imposition job information. The CPU 51 of the inspection server 50 inspects the inspection areas in a print image on a medium on which document pages are arranged by imposition by comparing the inspection areas with the correct answer data that is associated with the document pages included in the corresponding imposition page, based on the specifying information of the inspection areas, the correct answer data, and the document page numbers included in this imposition page.

For example, the CPU 11 obtains the correct answer data 110, such as that shown in FIG. 7, linked with the document 112. As shown in FIG. 8, the CPU 11 also obtains the information 128 indicating that, instead of the inspection areas 114 (area A and area B, for example) in the document 112, the inspection areas 126 (“1:A” and “1:B” in FIG. 8, for example) in the corresponding imposition page 120 are specified. The CPU 11 determines the page numbers of the document 112 included in the imposition page 120, based on imposition job information.

For example, as shown in FIGS. 7 and 8, the CPU 51 inspects the inspection areas in a print image on a medium on which document pages are arranged by imposition by comparing the inspection areas with the correct answer data 110 that is associated with the document pages included in the corresponding imposition page 120, based on the information 128 of the inspection areas 126 in this imposition page 120, the correct answer data 110, and the document page numbers included in this imposition page 120.

In the information processing system 1, for each region where a page of a document is disposed in an imposition page, the CPU 11 of the print server 10 specifies the document page imposition number corresponding to a document page. For example, as shown in FIG. 8, for each region where a page of the document 112 is disposed in the imposition page 120, the CPU 11 specifies the document page imposition number 127 corresponding to a certain document page.

In the information processing system 1, based on the document page imposition numbers, the CPU 51 of the inspection server 50 determines which inspection area in a print image on a medium on which document pages are arranged by imposition is to be compared with which portion of the correct answer data and associates the determined inspection area with the determined portion of the correct answer data. For example, as shown in FIG. 8, based on the document page imposition numbers 127, the CPU 51 determines which inspection area in a print image on a medium on which document pages are arranged by imposition is to be compared with which portion of the correct answer data 110 and associates the determined inspection area with the determined portion of the correct answer data 110.

In the information processing system 1, the print server 10 and the inspection server 50 are separately provided. Instead of separately providing the print server 10 and the inspection server 50, one processor disposed in the same server may execute processing.

### Modified Examples

In the first exemplary embodiment, based on the document page imposition numbers, the CPU 51 of the inspection server 50 determines which inspection area in a print image on a medium on which document pages are arranged by imposition is to be compared with which portion of the correct answer data and associates the determined inspection area with the determined portion of the correct answer data. However, the disclosure is not limited to this configuration.

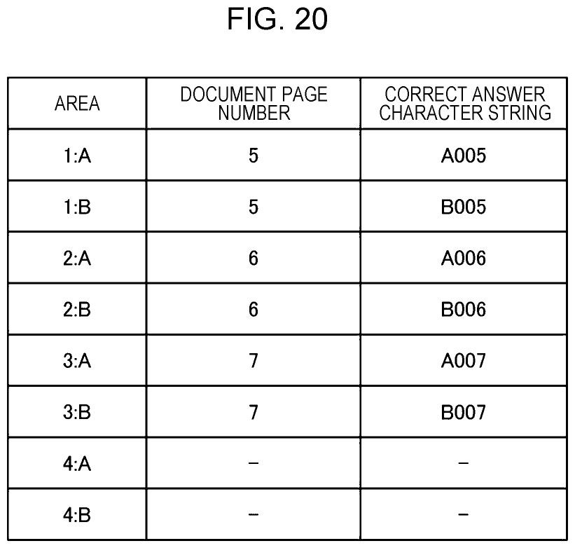

In an information processing system of a modified example, the CPU 11 of the print server 10 may associate the inspection areas in an imposition page with the portions of the correct answer data and send the association results to the inspection server 50. If, in the 4-up imposition in the first example, the second imposition page (page 5 to page 7 of a document) is to be inspected, the CPU 11 creates an association table shown in FIG. 20, for example. The CPU 11 then sends data on the association table in FIG. 20, for example, to the inspection server 50.

The CPU 51 of the inspection server 50 performs comparison inspection to inspect the inspection areas in a print image on a medium on which the document pages are arranged by imposition by comparing the inspection areas with the corresponding portions of the correct answer data, based on the data on the association table in FIG. 20.

### Second Exemplary Embodiment

An information processing system according to a second exemplary embodiment will now be described below. The same element as that of the first exemplary embodiment is designated by like reference numeral and an explanation thereof will be omitted.

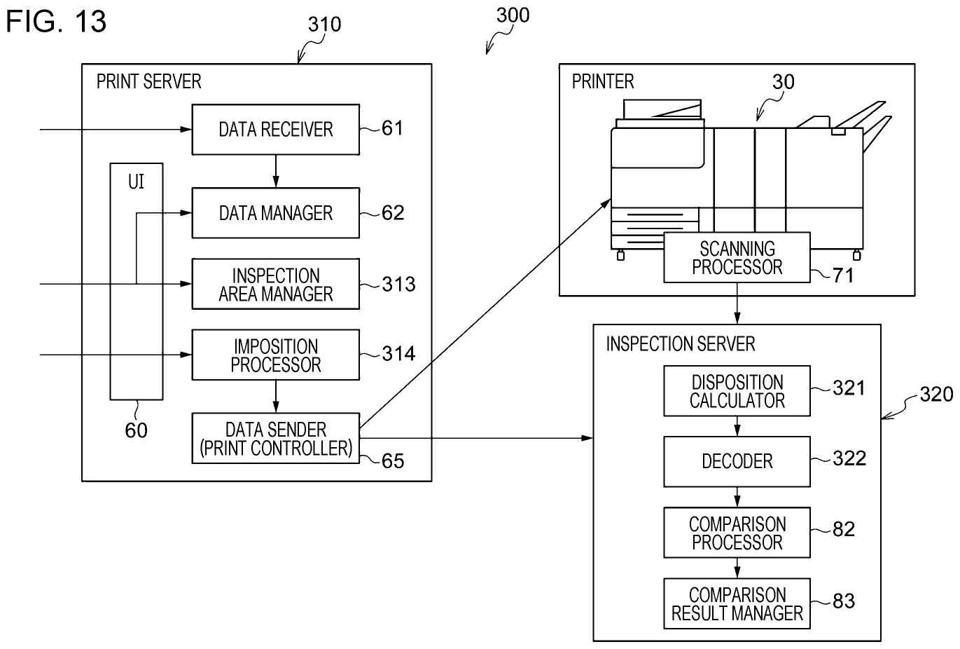

FIG. 13 is a block diagram illustrating an example of the functional configuration of an information processing system 300 according to the second exemplary embodiment. As illustrated in FIG. 13, the information processing system 300 includes a print server 310, a printer 30, and an inspection server 320. The hardware configuration of the print server 310 is similar to that of the first exemplary embodiment shown in FIG. 2. The hardware configuration of the inspection server 320 is similar to that of the first exemplary embodiment shown in FIG. 3.

The print server 310 includes, as functional modules, a data receiver 61, a data manager 62, an inspection area manager 313, an imposition processor 314, and a data sender 65.

The inspection server 320 includes, as functional modules, a disposition calculator 321, a decoder 322, a comparison processor 82, and a comparison result manager 83.

In response to a user instruction or automatically, the inspection area manager 313 creates and edits inspection areas for each document page in accordance with a document and registers the inspection areas included in each document page. Creating and registering inspection areas for each document page is an example of a presetting operation.

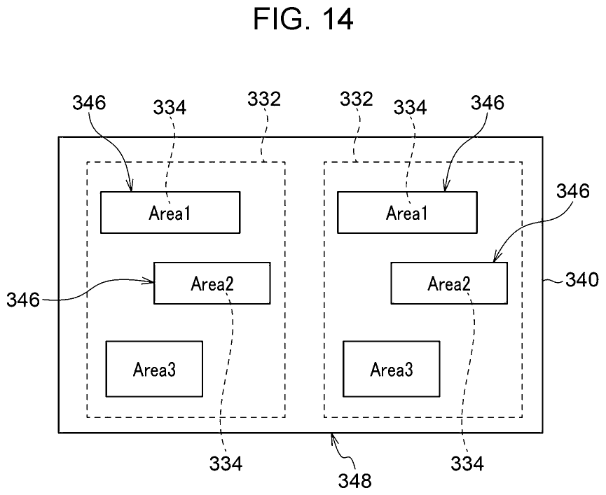

FIG. 14 illustrates an example of an imposition page (physical page) 340 on which pages of a document 332 are arranged by imposition. As shown in FIG. 14, in the document 332, inspection areas 334 are set in each document page.

The imposition processor 314 executes processing for starting printing and processing for inspecting a printed matter in response to a user operation performed on the user interface 60. The imposition processor 314 makes calculation for the imposition arrangement based on job information (job settings, for example) so as to determine the document page numbers of all the document pages included in a corresponding imposition page (physical page), the position (coordinates) of each document page on the imposition page, and the scaling ratio and the rotation of each document page.

The data sender 65 sends information on the inspection areas in each document page, the correct answer data, the document page numbers in the corresponding imposition page (physical page), the position (coordinates) of each document page on the imposition page, and the scaling ratio and the rotation of each document page to the inspection server 320. More specifically, the data sender 65 sends information on the inspection areas in each document page, the document page numbers in the corresponding imposition page (physical page), the position (coordinates) of each document page on the imposition page, and the scaling ratio and the rotation of each document page to the disposition calculator 321 and the correct answer data to the comparison processor 82.

The scanning processor 71 of the printer 30 scans the imposition page (physical page) on which an image is printed and sends the imposition page number (physical page number) and the scanned image to the decoder 322 of the inspection server 320.

The disposition calculator 321 makes calculation for the positional arrangement of the inspection areas in a corresponding imposition page (physical page) from information on the inspection areas in each document page, the document page numbers included in the imposition page (physical page), the position (coordinates) of each document page on the imposition page, and the scaling ratio and the rotation of each document page. For example, as shown in FIG. 14, the disposition calculator 321 makes calculation for the positional arrangement of inspection areas 346 in the corresponding imposition page (physical page) 340. With this operation, information 348 indicating that, instead of the inspection areas 334 in the document 332, the inspection areas 346 in the imposition page (physical page) 340 are specified is generated.

Based on the calculated positional arrangement of the inspection areas 346 included in the imposition page (physical page) 340, the decoder 322 decodes each inspection area in a scanned image (imposition page). For example, as shown in FIG. 14, based on the inspection areas 346 included in the corresponding imposition page (physical page) 340, the decoder 322 decodes each inspection area in a scanned image (imposition page). That is, the decoder 322 disposes the inspection areas 346 on the imposition page (physical page) 340 so that the inspection areas 346 match those in the scanned image. The decoder 322 then sends the imposition page number (physical page number) and the decoding results to the comparison processor 82.

The comparison processor 82 performs comparison inspection to compare the decoding results of the scanned image of the imposition page with the correct answer data that is associated with the document pages included in the imposition page. The comparison processor 82 notifies the comparison result manager 83 of the comparison inspection results.

The configurations of the other elements of the information processing system 300 are similar to those of the information processing system 1 of the first exemplary embodiment.

### (Operation of Information Processing System)

The operation of the information processing system 300 will now be described below.

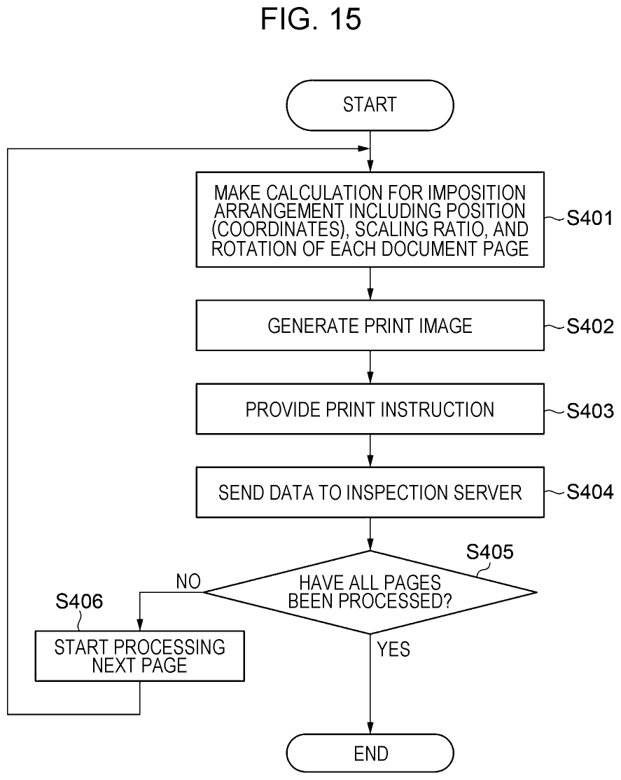

FIG. 15 is a flowchart illustrating a procedure of information processing executed by the print server 310 of the information processing system 300. The information processing is executed as a result of the CPU 11 reading the information processing program from the ROM 12, loading it to the RAM 13, and executing it.

The print server 310 performs the following presetting operation. The CPU 11 receives a document and correct answer data linked with the document from an external device and registers the received data in the data manager 62. In response to a user operation or automatically, the CPU 11 creates and edits inspection areas for each document page in accordance with the document and registers the inspection areas in the inspection area manager 313. Then, the CPU 11 provides an instruction to start printing and inspection in response to a user operation.

In step S401 in FIG. 15, when printing is started, the CPU 11 makes calculation for the imposition arrangement. More specifically, the CPU 11 makes calculation for the imposition arrangement based on job information (job settings, for example). Calculation for the imposition arrangement includes calculation of the document page numbers included in a corresponding imposition page (physical page), the position (coordinates) of each document page on the imposition page, and the scaling ratio and the rotation of each document page.

In step S402, the CPU 11 generates data on a print image. For example, the CPU 11 generates data on a print image, based on the document pages and the document page numbers included in the imposition page.

In step S403, the CPU 11 provides a print instruction to the printer 30. The print instruction is provided for each page (imposition page in this example).

In step S404, the CPU 11 sends data for inspection to the inspection server 320. The data for inspection includes data on the inspection areas in each document page, the correct answer data, the document page numbers included in the corresponding imposition page (physical page), the position (coordinates) of each document page on the imposition page, and the scaling ratio and the rotation of each document page. For example, information on the inspection areas 334 in each page of the document 332, the correct answer data, the document page numbers included in the imposition page (physical page), and the position (coordinates) of each document page on the imposition page, and the scaling ratio and the rotation of each document page is sent to the inspection server 320.

In step S405, the CPU 11 determines whether all the pages have been processed. The pages are imposition pages in this example.

If not all the pages have been processed (NO in step S405), the CPU 11 proceeds to step S406 to process the next page. In this case, the CPU 11 executes steps S401 through S405 for the next page.

If all the pages have been processed (YES in step S405), the CPU 11 finishes the processing executed based on the information processing program.

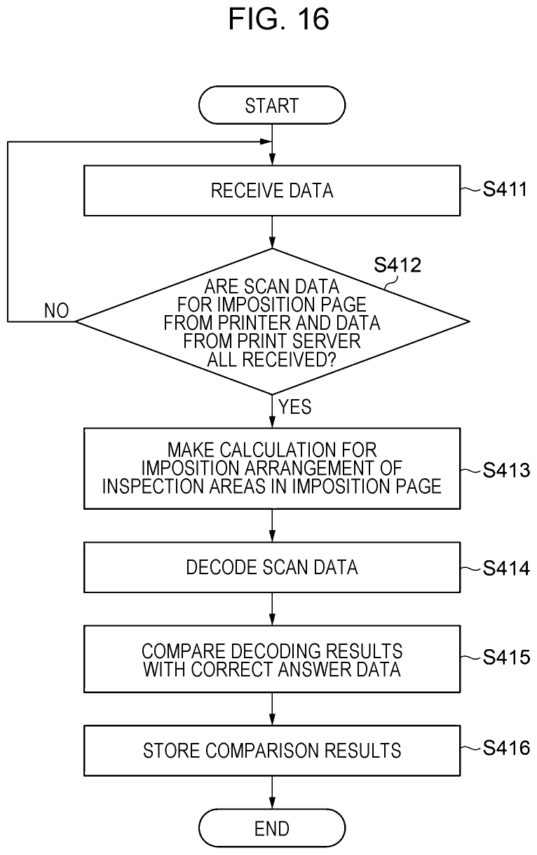

FIG. 16 is a flowchart illustrating a procedure of information processing executed by the inspection server 320 of the information processing system 300. The information processing is executed as a result of the CPU 51 reading the inspection program from the ROM 52, loading it to the RAM 53, and executing it.

In step S411 in FIG. 16, the CPU 51 receives data from the print server 310 and the printer 30. The data received from the print server 310 includes data on the inspection areas in each document page, the correct answer data, the document page numbers included in the corresponding imposition page (physical page), the position (coordinates) of each document page on the imposition page, and the scaling ratio and the rotation of each document page. The data received from the printer 30 includes scan data generated by scanning a printed matter (scanned image data).

In step S412, the CPU 51 determines whether scan data for the imposition page from the printer 30 and data from the print server 310 are all received. For example, if scan data for the imposition page has been received from the printer 30 and if data on the inspection areas in each document page, the correct answer data, and the above-described items of information in the corresponding imposition page have been received from the print server 310, the CPU 51 determines that the necessary items of data are all received.

If scan data for the imposition page from the printer 30 and data from the print server 310 are not all received (NO in step S412), the CPU 51 returns to step S411 and waits until the necessary items of data are all received.

If scan data for the imposition page from the printer 30 and data from the print server 310 are all received (YES in step S412), the CPU 51 makes calculation for the positional arrangement of the inspection areas in the corresponding imposition page in step S413. More specifically, the CPU 51 makes calculation for the positional arrangement of the inspection areas in the corresponding imposition page (physical page) based on the inspection areas in each document page, the document page numbers included in the imposition page (physical page), the position (coordinates) of each document page on the imposition page, and the scaling ratio and the rotation of each document page. For example, the CPU 51 calculates the positional arrangement of the inspection areas 346 in the imposition page 340, as shown in FIG. 14.

The CPU 51 decodes the scan data in step S414. For example, based on the calculated positional arrangement of the inspection areas 346 in the imposition page (physical page) 340, as shown in FIG. 14, the CPU 51 decodes each inspection area 346 in a scanned image (imposition page).

In step S415, the CPU 51 compares the decoding results with the correct answer data. For example, the CPU 51 compares the decoding results of the scanned image of the imposition page with the correct answer data that is associated with the document pages included in the imposition page and checks whether the decoding results match the correct answer data.

In step S416, the CPU 51 stores the comparison results, that is, the results of comparison inspection. Then, the CPU 51 finishes the processing executed based on the inspection program.

In the above-described information processing system 300, when performing inspection for a print image on a medium on which the pages of a document are arranged by imposition by comparing the print image with correct answer data, the CPU 51 of the inspection server 320 obtains information indicating that, instead of inspection areas included in the document, inspection areas corresponding to an imposition page on which the pages of the document are arranged are specified. For example, as shown in FIG. 14, the CPU 51 obtains the information 348 indicating that, instead of the inspection areas 334 (“Area 1”, “Area 2”, and “Area 3” in FIG. 14) in the document 332, the inspection areas 346 corresponding to the imposition page 340 on which the pages of the document 332 are arranged by imposition are specified.

In the information processing system 300, the CPU 51 of the inspection server 320 inspects the above-described inspection areas in the print image on the medium by comparing the inspection areas with the correct answer data that is associated with the document pages included in the imposition page and including the inspection areas, based on the above-described information that, instead of the inspection areas in the document, the inspection areas corresponding to the imposition page are specified. For example, based on the information 348 indicating that the inspection areas 346 corresponding to the imposition page 340 are specified, as shown in FIG. 14, the CPU 51 inspects the inspection areas in the scanned image by comparing the inspection areas with the correct answer data that is associated with the pages of the document 332 included in the imposition page 340.

In the information processing system 300, the CPU 11 of the print server 310 obtains correct answer data linked with the document 332. For the inspection areas in the document 332, the CPU 11 specifies the inspection areas 334 in each document page. The CPU 11 calculates the document page numbers and the positions of the document pages included in a corresponding imposition page 340, based on imposition job information. The CPU 51 of the inspection server 320 makes calculation for the positional arrangement of the inspection areas 346 in the corresponding imposition page 340, based on the inspection areas 334 in each document page and the document page numbers and the positions of the document pages included in the imposition page 340. When performing inspection for a print image on a medium on which document pages are arranged by imposition, the CPU 51 inspects the inspection areas in the print image on the medium by comparing the inspection areas with the correct answer data that is associated with the document pages included in the corresponding imposition page 340, based on information on the positional arrangement of the inspection areas 346 in the imposition page 340.

In the information processing system 300, the print server 310 and the inspection server 320 are separately provided. Instead of separately providing the print server 310 and the inspection server 320, one processor disposed in the same server may execute processing.

### Third Exemplary Embodiment

An information processing system according to a third exemplary embodiment will now be described below. The same element as that of the first or second exemplary embodiment is designated by like reference numeral and an explanation thereof will be omitted.

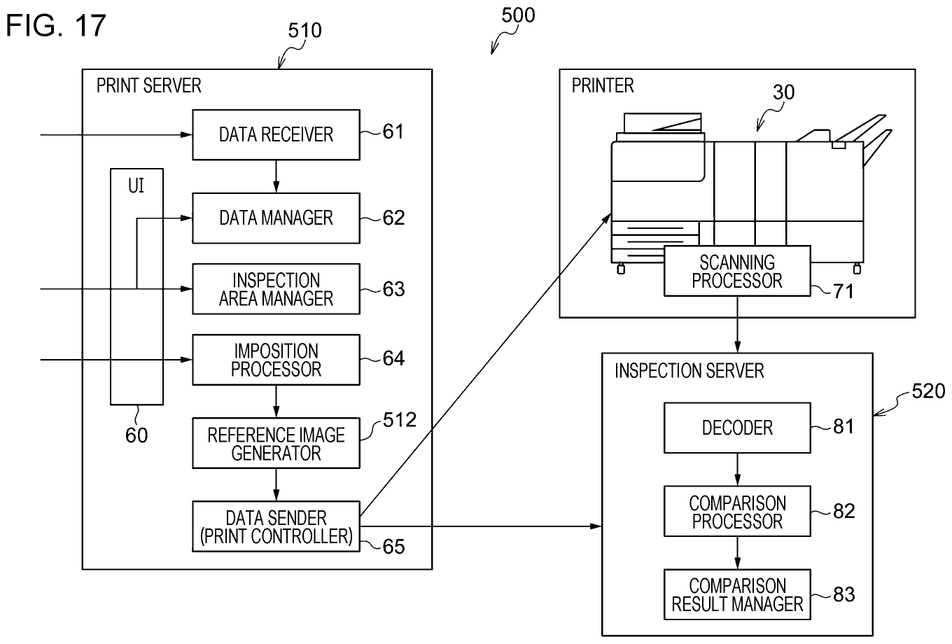

FIG. 17 is a block diagram illustrating an example of the functional configuration of an information processing system 500 according to the third exemplary embodiment. As illustrated in FIG. 17, the information processing system 500 includes a print server 510, a printer 30, and an inspection server 520. The hardware configuration of the print server 510 is similar to that of the first exemplary embodiment shown in FIG. 2. The hardware configuration of the inspection server 520 is similar to that of the first exemplary embodiment shown in FIG. 3. The information processing system 500 is different from the information processing system 1 of the first exemplary embodiment in that inspection is performed without receiving correct answer data (a list of character strings of correct answers).

The print server 510 includes, as functional modules, a data receiver 61, a data manager 62, an inspection area manager 63, an imposition processor 64, a reference image generator 512, and a data sender 65.

The inspection server 520 includes, as functional modules, a decoder 81, a comparison processor 82, and a comparison result manager 83.

The data receiver 61 receives data on a document from an external device.

In response to a user instruction or automatically, the inspection area manager 63 creates and edits inspection areas for a corresponding imposition page (physical page) in accordance with the document and registers information indicating that inspection areas included in this imposition page are specified. Information indicating that the inspection areas included in the corresponding imposition page are specified is an example of specifying information of inspection areas. Creating, editing, and registering inspection areas for a corresponding imposition page is an example of a presetting operation and is performed similarly to the first exemplary embodiment.

The imposition processor 64 makes calculation for the imposition arrangement based on job information (job settings, for example).

The reference image generator 512 generates a reference image based on a raster image processor (RIP) image created for performing printing. RIP is a dedicated software component that converts input print data into a raster image that can be used for printing. The RIP image is an example of a printing image created for performing printing from information on a document. The reference image is an image in which imposition results are reflected.

The data sender 65 sends the reference image and data on the inspection areas in a corresponding imposition page to the decoder 81 of the inspection server 520.

The scanning processor 71 of the printer 30 scans the imposition page (physical page) on which an image is printed and sends the imposition page number (physical page number) and the scanned image to the decoder 81 of the inspection server 520.

Based on the received inspection areas in the corresponding imposition page, the decoder 81 decodes the reference image and each inspection area in the scanned image. In one example, character strings obtained by decoding barcodes in the reference image are set to be correct answer data. In this manner, correct answer data can be generated from the reference image in which the imposition results are reflected. The decoder 81 then sends the imposition page number (physical page number), the decoding results of the reference image, and the decoding results of the scanned image to the comparison processor 82. In this example, both of the reference image and the scanned image are images of the imposition page (physical page) in which the imposition results are reflected.

The comparison processor 82 performs comparison inspection to compare the decoding results of the reference image with those of the scanned image. The comparison processor 82 notifies the comparison result manager 83 of the comparison inspection results.

The configurations of the other elements of the information processing system 500 are similar to those of the information processing system 1 of the first exemplary embodiment.

### (Operation of Information Processing System)

The operation of the information processing system 500 will now be described below.

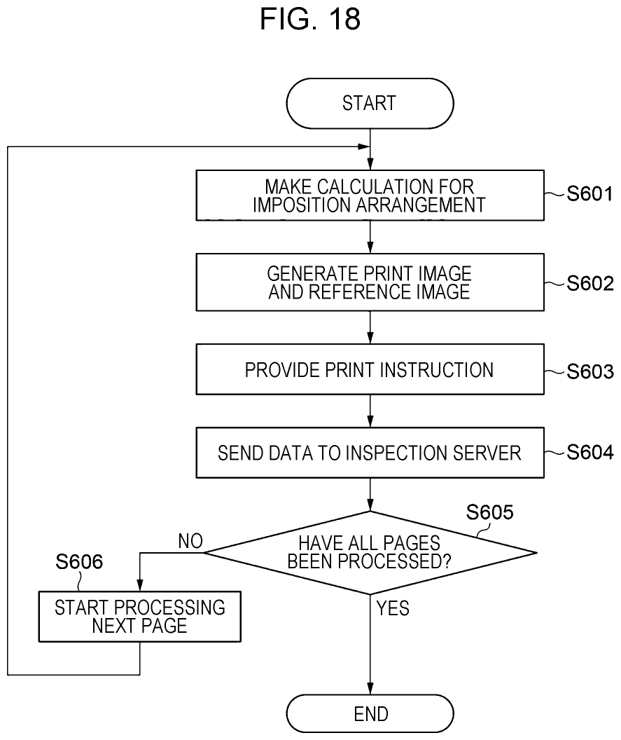

FIG. 18 is a flowchart illustrating a procedure of information processing executed by the print server 510 of the information processing system 500. The information processing is executed as a result of the CPU 11 reading the information processing program from the ROM 12, loading it to the RAM 13, and executing it.

The print server 510 performs the following presetting operation. The CPU 11 receives data on a document from an external device and registers the received data in the data manager 62. In response to a user operation or automatically, the CPU 11 creates and edits inspection areas for a corresponding imposition page in accordance with the document so as to obtain information indicating that the inspection areas in this imposition page are specified and registers this information in the inspection area manager 63. Then, the CPU 11 provides an instruction to start printing and inspection in response to a user operation.

In step S601 in FIG. 18, when printing is started, the CPU 11 makes calculation for the imposition arrangement. More specifically, the CPU 11 makes calculation for the imposition arrangement based on job information (job settings, for example).

In step S602, the CPU 11 generates a reference image and data on a print image. For example, the CPU 11 generates data on a print image and a reference image, based on the document pages and the document page numbers included in the corresponding imposition page. In one example, the CPU 11 generates a reference image based on a RIP image created for performing printing.

In step S603, the CPU 11 provides a print instruction to the printer 30. The print instruction is provided for each page (imposition page in this example).

In step S604, the CPU 11 sends data for inspection to the inspection server 520. The data for inspection includes data on the inspection areas in the corresponding imposition page, the reference image, and the document page numbers included in the imposition page (physical page), for example.

In step S605, the CPU 11 determines whether all the pages have been processed. The pages are imposition pages in this example.

If not all the pages have been processed (NO in step S605), the CPU 11 proceeds to step S606 to process the next page. In this case, the CPU 11 executes steps S601 through S605 for the next page.

If all the pages have been processed (YES in step S605), the CPU 11 finishes the processing executed based on the information processing program.

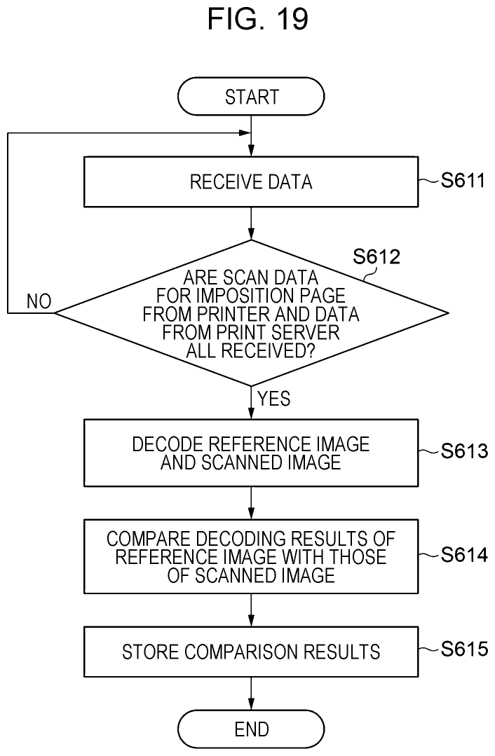

FIG. 19 is a flowchart illustrating a procedure of information processing executed by the inspection server 520 of the information processing system 500. The information processing is executed as a result of the CPU 51 reading the inspection program from the ROM 52, loading it to the RAM 53, and executing it.

In step S611 in FIG. 19, the CPU 51 receives data from the print server 510 and the printer 30. The data received from the print server 510 includes data on the inspection areas in the corresponding imposition page (physical page) and the document page numbers included in the imposition page, for example. The data received from the printer 30 includes scan data generated by scanning a printed matter (scanned image data).

In step S612, the CPU 51 determines whether scan data for the imposition page from the printer 30 and data from the print server 510 are all received. For example, if scan data for the imposition page has been received from the printer 30 and if data on the inspection areas in the imposition page (physical page) and information on the document page numbers included in the imposition page, for example, have been received from the print server 510, the CPU 51 determines that the necessary items of data are all received.

If scan data for the imposition page from the printer 30 and data from the print server 510 are not all received (NO in step S612), the CPU 51 returns to step S611 and waits until the necessary items of data are all received.

If scan data for the imposition page from the printer 30 and data from the print server 510 are all received (YES in step S612), the CPU 51 decodes the reference image and the scanned image in step S613. More specifically, based on the inspection areas in the corresponding imposition page, the CPU 51 decodes the reference image and each inspection area in the scanned image. In one example, character strings obtained by decoding barcodes in the reference image are set to be correct answer data.

In step S614, the CPU 51 compares the decoding results of the reference image with those of the scanned image. For example, the CPU 51 compares the decoding results of the reference image (that is, correct answer data) with the decoding results of the scanned image and checks whether the decoding results of the two images match each other.

In step S615, the CPU 51 stores the comparison results, that is, the results of comparison inspection. Then, the CPU 51 finishes the processing executed based on the inspection program.

In the above-described information processing system 500, when performing inspection for a print image on a medium on which the pages of a document are arranged by imposition by comparing the print image with correct answer data, the CPU 11 or 51 obtains information indicating that, instead of inspection areas included in the document, inspection areas corresponding to an imposition page on which the pages of the document are arranged are specified.

In the information processing system 500, the CPU 51 of the inspection server 520 inspects the above-described inspection areas in the print image on the medium by comparing the inspection areas with the correct answer data that is associated with the document pages included in the imposition page and including the inspection areas, based on the above-described information that, instead of the inspection areas in the document, the inspection areas corresponding to the imposition page are specified.

In the information processing system 500, the CPU 11 of the print server 510 obtains specifying information indicating that, instead of inspection areas in the document, inspection areas included in a corresponding imposition page are specified. The CPU 11 generates a reference image in which the imposition results are reflected, based on a printing image created for performing printing from information on the document.

The CPU 51 of the inspection server 520 creates correct answer data from the reference image in which the imposition results are reflected. Based on the specifying information of the inspection areas, the CPU 51 inspects the inspection areas in a print image on a medium on which the page of a document are arranged by imposition by comparing the inspection areas with portions of the correct answer data that are associated with the inspection areas.

In the information processing system 500, the print server 510 and the inspection server 520 are separately provided. Instead of separately providing the print server 510 and the inspection server 520, one processor disposed in the same server may execute processing.

### Others

The information processing system according to an exemplary embodiment of the disclosure is not limited to the information processing systems 1, 300, and 500 of the first through third exemplary embodiments. Various modifications may be made on the information processing systems 1, 300, and 500.

The above-described processing executed by the information processing systems, 1, 300, and 500 may be implemented by a dedicated hardware circuit. In this case, the processing may be executed by one hardware unit or multiple hardware units.

Programs for operating the information processing systems, 1, 300, and 500 may be provided as a result of being recorded on a computer readable recording medium, such as a universal serial bus (USB) memory, a flexible disk, and a compact disc-read only memory (CD-ROM), or may be provided online via a network, such as the internet. The programs recorded on a computer readable recording medium are typically transferred to a memory or a storage, for example, and are stored. The programs may be provided as single application software or be integrated into software in the devices of the information processing system 1 as one function of the information processing system 1.

In the exemplary embodiments, the processes are performed by any computer. The computer may perform the processes by using a processor serving as hardware, a program serving as software, or combination of these. In this case, the processor is configured to perform the processes in the exemplary embodiments in cooperation with the program and may function as a unit or a means in the exemplary embodiments. The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU). Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage). The program may be stored in such a divided manner in multiple non-transitory computer readable media present in apparatuses physically away from each other. The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

An information processing system comprising:
a processor configured to:
   obtain, when performing inspection for a print image on a medium on which pages of a document are arranged by imposition by comparing the print image with correct answer data, information indicating that, instead of inspection areas included in the document, inspection areas corresponding to an imposition page on which the pages of the document are arranged by imposition are specified.
      (((2)))

The information processing system according to (((1))), wherein the processor is configured to inspect, based on the information, the inspection areas in the print image on the medium by comparing the inspection areas with correct answer data that is associated with the pages of the document included in the imposition page and including the inspection areas.

(((3)))

### The Information Processing System According to (((1))) or (((2))), Wherein the Processor is configured to:

obtain correct answer data linked with the document;
obtain specifying information indicating that, instead of the inspection areas included in the document, inspection areas in a corresponding imposition page are specified;
determine document page numbers of the pages of the document included in the corresponding imposition page, based on imposition job information; and
inspect the inspection areas in the print image on the medium by comparing the inspection areas with the correct answer data that is associated with the pages of the document included in the corresponding imposition page, based on the specifying information, the correct answer data, and the document page numbers included in the corresponding imposition page.
   (((4)))

The information processing system according to (((3))), wherein the processor is configured to specify, for each region where a page of the document is disposed in the corresponding imposition page, a document page imposition number corresponding to the page of the document.

(((5)))

The information processing system according to (((4))), wherein the processor is configured to determine, based on the document page imposition number corresponding to each of the pages of the document, which inspection area in the print image on the medium is to be compared with which portion of the correct answer data and to associate the determined inspection area with the determined portion of the correct answer data.

(((6)))

The information processing system according to (((1))) or (((2))), wherein the processor is configured to:
obtain correct answer data linked with the document;
specify, for the inspection areas in the document, the inspection areas in each of the pages of the document;
determine document page numbers and positions of the pages of the document included in a corresponding imposition page, based on imposition job information;
make calculation for positional arrangement of the inspection areas in the corresponding imposition page, based on the inspection areas in each of the pages of the document and based on the document page numbers and the positions of the pages of the document included in the corresponding imposition page; and
inspect, when performing inspection for a print image on a medium on which the pages of the document are arranged by imposition, the inspection areas in the print image on the medium by comparing the inspection areas with the correct answer data that is associated with the pages of the document included in the corresponding imposition page, based on information on the positional arrangement of the inspection areas in the corresponding imposition page.
   (((7)))

The information processing system according to (((1))) or (((2))), wherein the processor is configured to:
obtain specifying information indicating that, instead of the inspection areas included in the document, inspection areas in a corresponding imposition page are specified;
generate a reference image in which imposition results are reflected, based on a printing image created for performing printing from information on the document;
create correct answer data from the reference image; and
inspect, based on the specifying information, the inspection areas in the print image on the medium on which the pages of the document are arranged by imposition by comparing the inspection areas with portions of the correct answer data that are associated with the inspection areas.
   (((8)))

A program causing a computer to execute a process for information processing, the process comprising:
obtaining, when performing inspection for a print image on a medium on which pages of a document are arranged by imposition by comparing the print image with correct answer data, information indicating that, instead of inspection areas included in the document, inspection areas corresponding to an imposition page on which the pages of the document are arranged by imposition are specified.
   (((9)))

The program according to (((8))), the process further comprising:
inspecting, based on the information, the inspection areas in the print image on the medium by comparing the inspection areas with correct answer data that is associated with the pages of the document included in the imposition page and including the inspection areas.
   (((10)))

An information processing method performed by a computer, comprising:
obtaining, when performing inspection for a print image on a medium on which pages of a document are arranged by imposition by comparing the print image with correct answer data, information indicating that, instead of inspection areas included in the document, inspection areas corresponding to an imposition page on which the pages of the document are arranged by imposition are specified.
   (((11)))

The information processing method according to (((10))), further comprising:
inspecting, based on the information, the inspection areas in the print image on the medium by comparing the inspection areas with correct answer data that is associated with the pages of the document included in the imposition page and including the inspection areas.

What is claimed is:

1. An information processing system comprising:
a processor configured to:
obtain, when performing inspection for a print image on a medium on which pages of a document are arranged by imposition by comparing the print image with correct answer data, information indicating that, instead of inspection areas included in the document, inspection areas corresponding to an imposition page on which the pages of the document are arranged by imposition are specified.

2. The information processing system according to claim 1, wherein the processor is configured to inspect, based on the information, the inspection areas in the print image on the medium by comparing the inspection areas with correct answer data that is associated with the pages of the document included in the imposition page and including the inspection areas.

3. The information processing system according to claim 1, wherein the processor is configured to:
obtain correct answer data linked with the document;
obtain specifying information indicating that, instead of the inspection areas included in the document, inspection areas in a corresponding imposition page are specified;
determine document page numbers of the pages of the document included in the corresponding imposition page, based on imposition job information; and
inspect the inspection areas in the print image on the medium by comparing the inspection areas with the correct answer data that is associated with the pages of the document included in the corresponding imposition page, based on the specifying information, the correct answer data, and the document page numbers included in the corresponding imposition page.

4. The information processing system according to claim 3, wherein the processor is configured to specify, for each region where a page of the document is disposed in the corresponding imposition page, a document page imposition number corresponding to the page of the document.

5. The information processing system according to claim 4, wherein the processor is configured to determine, based on the document page imposition number corresponding to each of the pages of the document, which inspection area in the print image on the medium is to be compared with which portion of the correct answer data and to associate the determined inspection area with the determined portion of the correct answer data.

6. The information processing system according to claim 1, wherein the processor is configured to:
obtain correct answer data linked with the document;
specify, for the inspection areas in the document, the inspection areas in each of the pages of the document;
determine document page numbers and positions of the pages of the document included in a corresponding imposition page, based on imposition job information;
make calculation for positional arrangement of the inspection areas in the corresponding imposition page, based on the inspection areas in each of the pages of the document and based on the document page numbers and the positions of the pages of the document included in the corresponding imposition page; and
inspect, when performing inspection for a print image on a medium on which the pages of the document are arranged by imposition, the inspection areas in the print image on the medium by comparing the inspection areas with the correct answer data that is associated with the pages of the document included in the corresponding imposition page, based on information on the positional arrangement of the inspection areas in the corresponding imposition page.

7. The information processing system according to claim 1, wherein the processor is configured to:
obtain specifying information indicating that, instead of the inspection areas included in the document, inspection areas in a corresponding imposition page are specified;
generate a reference image in which imposition results are reflected, based on a printing image created for performing printing from information on the document;
create correct answer data from the reference image; and
inspect, based on the specifying information, the inspection areas in the print image on the medium on which the pages of the document are arranged by imposition by comparing the inspection areas with portions of the correct answer data that are associated with the inspection areas.

8. A non-transitory computer readable medium storing a program causing a computer to execute a process comprising:
obtaining, when performing inspection for a print image on a medium on which pages of a document are arranged by imposition by comparing the print image with correct answer data, information indicating that, instead of inspection areas included in the document, inspection areas corresponding to an imposition page on which the pages of the document are arranged by imposition are specified.

9. The non-transitory computer readable medium according to claim 8, the process further comprising:
inspecting, based on the information, the inspection areas in the print image on the medium by comparing the inspection areas with correct answer data that is associated with the pages of the document included in the imposition page and including the inspection areas.

10. An information processing method comprising:
obtaining, when performing inspection for a print image on a medium on which pages of a document are arranged by imposition by comparing the print image with correct answer data, information indicating that, instead of inspection areas included in the document, inspection areas corresponding to an imposition page on which the pages of the document are arranged by imposition are specified.

11. The information processing method according to claim 10, further comprising:
inspecting, based on the information, the inspection areas in the print image on the medium by comparing the inspection areas with correct answer data that is associated with the pages of the document included in the imposition page and including the inspection areas.
